(19) United States
(12) Patent Application Publication
(10) Pub. No.: US 2008/0101169 A1
(43) Pub. Date: May 1, 2008

(54) OPTICAL DISC DEVICE AND METHOD FOR FOCUS CONTROL

(76) Inventors: KOICHI SUZUKI, Hitachinaka (JP); Nobuo Nakai, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/747,248

(22) Filed: May 11, 2007

(30) Foreign Application Priority Data
Oct. 27, 2006 (JP) JP 2006-292445

(51) Int. Cl. G11B 7/00

(52) U.S. Cl. 369/44.13

(57) ABSTRACT

The present invention provides an optical disc device and a method for focus control which enable an efficient operation for focusing without giving damages to an optical disc. A focus control section detects a focus position (drive voltage V1) by shifting an objective lens in the state where the optical disc is stopped (first step). Then, an amplitude (V2) of vertical deviation of the optical disc is detected from a reflected optical signal from the optical disc obtained by giving minute wobbling to the objective lens in the state where the optical disc rotates (second step). Based on the detected amplitude of vertical deviation of the optical disc, limit values (V3) are set for preventing collision between the objective lens and the optical disc. Then focusing is performed within a range defined by the limit values (third step).

### CLAIM OF PRIORITY

The present application claims priority from Japanese application serial No. JP 2006-292445, filed on Oct. 27, 2006, the content of which is hereby incorporated by reference into this application.

### BACKGROUND OF THE INVENTION

(1) Field of the Invention

The present invention relates to an optical disc device for recording therein information by irradiating a light beam on a recording surface of an optical disc and for reproducing the information therefrom.

(2) Description of the Related Art

Recently, the qualities of images displayed on displays have been rapidly improved, and now there is a demand for a three wavelength compatible optical disc device supporting a CD, DVD, and a BD (Blu-ray) disc using a short wavelength laser suitable for recording hi-vision broadcasting programs. On the other hand, an optical disc device mounted in a laptop personal computer is required to be thinner than that mounted in a desktop type personal computer. Therefore, a focal distance of an objective lens has been becoming shorter.

Because of the technical trend as described above, when a BD disc is loaded on a thin optical disc device mounted in a laptop computer, a working distance (hereinafter abbreviated as WD) between an objective lens (or a focus lens) and a surface of an optical disc is extremely short. Thus, the objective lens and the optical disc collide with each other and the optical disc is easily damaged.

Also, for a three wavelength compatible optical disc device mounted in a desktop type of a personal computer, studies are made on an objective lens supporting three wavelengths. Since each of a CD, DVD, and BD has a different depth between a surface of the optical disc and a recording surface thereof, which gives an influence to a WD between an objective lens and a surface of the optical disc. The objective lens and the optical disc may collide with each other and the optical disc may be damaged.

In the light of the circumstances as described above, the following technique has been proposed to prevent collision between an objective lens of a optical pickup and an optical disc.

The technique disclosed in Japanese Patent Laid-Open No. 2002-140823 aims at prevention of damages caused by collision between an objective lens of a optical pickup and an optical disc during a focus search operation. The optical pickup is driven toward a focus side by use of a gradually increasing amplitude of a signal. When the optical pickup reaches a region in which a focus servo is possible, the drive of the optical pickup is stopped. Thus, the collision can be avoided.

The technique disclosed in Japanese Patent Laid-Open No. 2004-273023 aims at performing a focus search operation by use of a minimum amplitude required for the center of a focal point. For a focus error signal, a first threshold value for preventing an objective lens and an optical disc from colliding with each other, and a second threshold value for preventing the objective lens and the optical disc from being too far from each other are provided. A optical pickup is driven so that the focus error signal is within a range between the two threshold values.

### SUMMARY OF THE INVENTION

The present inventor has the following findings concerning damages of an optical disc caused by an objective lens. In the case of a BD disc, since recording is performed by using a light beam with a short wavelength, the light intensity of a reflected light beam from the optical disc is low, and therefore it is difficult to detect a focus error signal. Because of this, influence of the vertical deviation of an optical disc on focus control becomes relatively larger, which deteriorates precision in control. Even if an objective lens and an optical disc collide with each other, the optical disc in a stationary state is almost not damaged, but is substantially damaged in a rotating state. Therefore, countermeasures are required for preventing influence by vertical deviation of a disc during rotation.

In the technique disclosed in Japanese Patent Laid-Open No. 2002-140823, the influence caused by vertical deviation of an optical disc during rotation is not taken into account. Assuming that this technique is applied when an optical disc rotates and vibrates in the vertical direction due to the vertical deviation, it is necessary to provide control with association of a gradually increasing amplitude used to drive an optical pickup with the vertical deviation of the optical disc. Inn this case, the control would be difficult. Furthermore, if a position at which the drive of the optical pickup is started and an end position where focus servo is possible are not close to each other, a long period of time is required for setting up. To reduce the time required for setting up, it is necessary to examine the starting point to be set.

Japanese Patent Laid-Open No. 2004-273023 does not describe a method for setting a threshold value for preventing collision between an objective lens and an optical disc. Even if a threshold value is determined based on an amplitude of a focus error signal like the conventional techniques, signals from a position of the reflecting surface other than the target recording surface are present, and a new technique is required for setting a reliable threshold value.

An object of the present invention is to provide an optical disc device and a method for focus control, which enable an efficient focusing operation without causing damages to an optical disc so as to reduce the influences caused by vertical deviation during rotation of an optical disc.

The optical disc device according to the present invention comprises a spindle motor which rotates an optical disc, a pickup, and a focus control section. The pickup includes: a laser beam source which generates a light beam; an objective lens which irradiates the light beam onto the optical disc; a photo detector which detects light reflected from the optical disc; and an actuator which shifts the objective lens in the focusing direction of the optical disc. The focus control section performs focus control by giving a focus control signal to the actuator. When starting the focus control, the focus control section detects an amplitude of vertical deviation of an optical disc from a reflected optical signal obtained by causing minute wobbling in the objective lens during rotation of the optical disc, sets limit values for preventing collision between the objective lens and the optical disc when the objective lens is shifted toward the optical disc, and performs focusing within the range defined by the limit values.

Furthermore, when starting the focus control, the focus control section at first shifts the objective lens while the optical disc is in a stationary state to detect a focus position on a recording surface of the optical disc, and then causes wobbling in the objective lens for a region around the focus position.

The focus control section has a wobbling signal generating circuit which generates a wobbling signal given to an objective lens for detection of an amplitude of vertical deviation of a rotating optical disc, a signal processing circuit which generates a summation signal from reflected optical signals from the optical disc, an automatic gain control circuit which references the level of the generated summation signal and adjusts a gain of a wobbling signal synchronized with the summation signal, and a low band pass filter circuit which rectifies the gain-adjusted wobbling signal.

In the focus control method according to the present invention, minute wobbling is generated in an objective lens for irradiating a light beam in the state where an optical disc rotates, an amplitude of vertical deviation of the optical disc is detected from the reflected optical signal from the optical disc, and limit values are set based on the detected amplitude of vertical deviation to prevent collision between the objective lens and the optical disc when the objective lens is shifted toward the optical disc. Then focusing is performed by shifting the objective lens in the focusing direction toward the optical disc within a range defined by the limit values.

### BRIEF DESCRIPTION OF THE DRAWINGS

FIG. 1 is a block diagram illustrating an optical disc device according to an embodiment of the present invention;

FIG. 2 is a view illustrating an example of a flow chart for focus control in the embodiment;

FIG. 3 is a view illustrating detection of an FOD voltage in a first step;

FIG. 4 is a block configuration diagram used in a sine wave learning process in a second step; and

FIG. 5 is a view illustrating a principle of detection of a defocusing rate in the sine wave learning process.

### DETAILED DESCRIPTION OF THE EMBODIMENTS

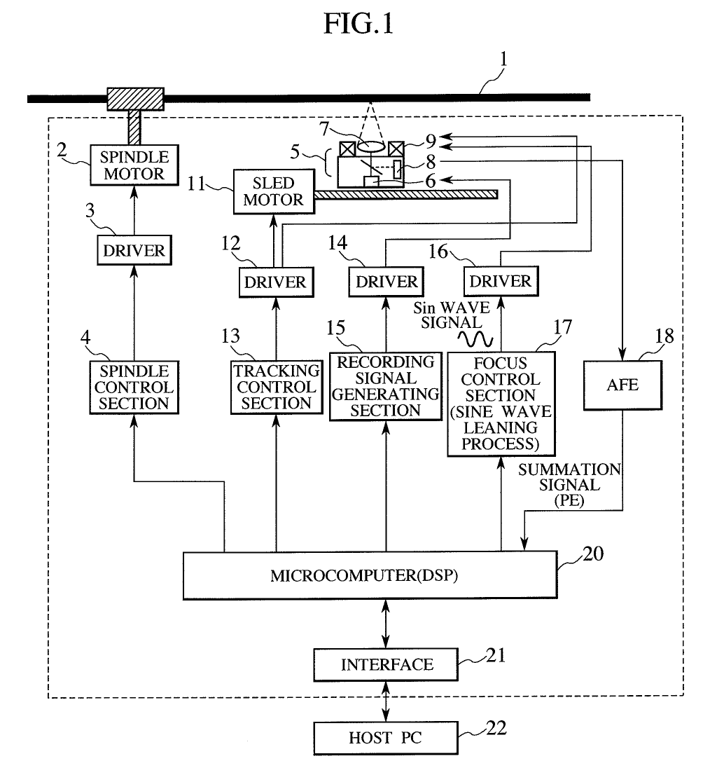

FIG. 1 is a block diagram illustrating an optical disc device according to an embodiment of the present invention. The device according to the embodiment rotates an optical disc 1 set therein by use of a spindle motor 2, irradiates a light beams from a pickup 5 to a recording surface of the optical disc 1, and records information in or reproduces the information from the optical disc. The pickup 5 moves in the radial direction of the optical disc when a sled motor 11 turns.

The spindle motor 2 is driven by a driver 3, and a spindle control section 4 controls rotation of the spindle motor 2. The sled motor 11 is driven by a driver 12, and a tracking control section 13 controls the sled motor 11 so as to move the pickup 5 in the radial direction of the disc at a predetermined interval.

The pickup 5 includes a laser diode (LD) 6 which is a laser beam source, an objective lens 7 for irradiating a light mean (a laser beam) to an optical disc, a photo detector 8 for detecting a signal from the optical disc, and an actuator 9. The actuator 9 is driven by the drivers 12, 16, and shifts the objective lens 7 in the direction along a depth of a disc (in the focusing direction) as well as in the radial direction of the disc (in the tracking direction). The photo detector 8 has a quadrant light-receiving surface, and sends four detection signals to a signal processing circuit (AFF) 18. The AFF 18 processes the signals to generate a focus signal. The following description assumes the case where a summation signal (hereinafter referred to as PE signal) for reflected light by summing up the quadrant signals, but also a focus error signal may be generated by executing subtraction processing for the quadrant signals.

A focus control section 17 and a microcomputer (DSP) 20 provide focus control via the driver 16 based on a summation signal (PE) from the AFE 18. In this embodiment, to avoid collision between the objective lens 7 and the optical disc 1 during a focusing operation, limit values are set for a focus drive voltage (FOD) applied to the actuator 9, and the focus sweep range is kept within a range defined by the limit values.

To set the limit values, a position of a recording surface is detected in the state where the optical disc is stopped, and in the state where the optical disc rotates. Especially, for detection in the state where the optical disc rotates, the wobbling system (sine wave learning system) described below is employed, and wobbling vibration is generated in the objective lens 7, and a focus displacement (defocusing rate) generated due to vertical deviation of the disc is detected. An amplitude of the wobbling vibration is sufficiently small with a frequency higher than a frequency of vertical deviation of the optical disc, so that components of vertical deviation of the optical disc are desirably detected.

An information signal to be recorded in an optical disc is input from a host personal computer 22 via an interface 21 into the microcomputer 20. A record signal generating section 15 generates a recording pulse signal corresponding to an information signal, and supplies the recording pulse signal via a driver 14 to an LD 6. The signal regenerated from light reflected from the optical disc by the photo detector 8 is converted to an information signal by the AFE 18, and is output via the microcomputer 20 and an interface 21 to a host personal computer 22.

To start focus control with the focus control section 17, it is necessary to detect a focus signal for the recording surface. However, in the optical disc device compatible to three wavelengths for BD, DVD and CD, since the WD is very narrow, when detecting a focus signal for the recording surface, the possibility of collision between an objective lens and a surface of an optical disc is very high because of influences caused by vertical deviation of the optical disc and other factors. In this embodiment, to prevent collision of an objective lens to an optical disc, a focus position (a focused focal point) of an objective lens on a recording surface of an optical disc is detected in the state where the optical disc is stopped. Then, minute wobbling is generated for a region around the focus position in the objective lens in the state where the optical disc is rotated. An amplitude of vertical deviation of the optical disc is detected. Limit values are set for preventing collision between the objective lens and the optical disc. Then, focusing is performed within a range defined by the limit values.

Specifically, the following steps are employed in this embodiment.

### [First step]: A focus actuator driving rate (described as FOD voltage hereinafter) V1 is detected, the rate V1 being corresponding to the recording surface of the optical disc in the state where the optical disc is stopped.

[Second step]: An FOD voltage V2 is detected which corresponds to the recording surface (vertical deviation) of the optical disc during rotation by superimposing a wobbling signal on the FOD voltage V1. This step is referred to as a process of learning a maximum FOD voltage (sine wave learning process) in the following description.

### [Third step]: A value obtained by adding a margin α to the FOD voltage V2 (FOD voltage V2+margin α) is set as a limit value V3 for a focus sweep voltage to perform focusing.

A principle of a learning process in the second step is as described below. When a position of a recording surface is displaced from a focus position of an objective lens due to vertical deviation during rotation of an optical disc, a PE signal for the reflected light is displaced from the maximum value. When the wobbling signal (sine wave) is superimposed on the FOD voltage in the state where the PE signal is off from the maximum value, an amplitude of the detected PE signal fluctuates asymmetrically. The asymmetrical component is extracted and is added as a defocusing rate to the FOD voltage. As a result, feedback control is provided so that an amplitude of the PE signal is symmetric, namely so that the focus position follows a maximum point of the PE signal. The corrected FOD voltage is described as voltage V2 below.

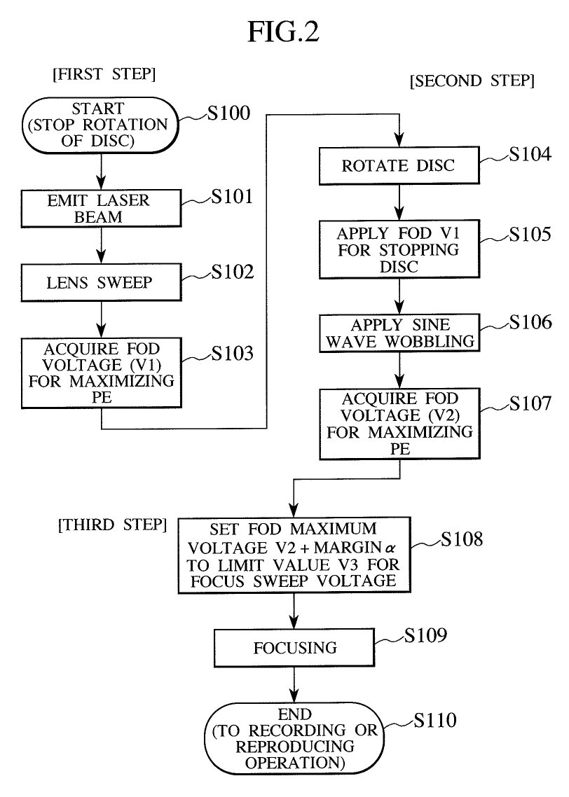

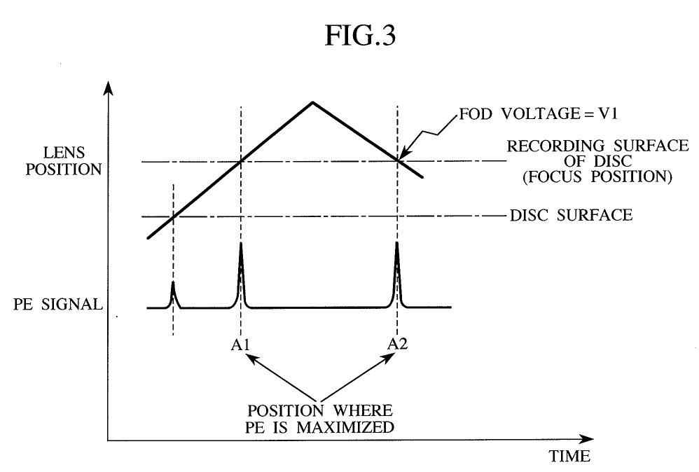

FIG. 2 is a view illustrating an example of a flow chart for focus control according to the present invention. Operations in each step are described in detail below with reference to FIG. 3 to FIG. 5.

### [First Step]

Rotation of an optical disc is stopped (S100). Then, a light beam is emitted from the laser beam source (LD6) (S101). The objective lens 7 is lowered to the sweep start position, and lens is swept toward the disc (s102). Then a summation signal (PE signal) for the reflected light is detected with the photo detector 8 and the AFE 18. The PE signal becomes the maximum at a position of a recording surface of a disc. Therefore, a position where the PE signal is maximized is determined as a recording surface of the disc, and the FOD voltage V1 at the time of the determination is acquired (S103). It is to be noted that a focus error signal (FE signal) may be used as a signal to be detected in this step in place of the PE signal. FIG. 3 is a view for illustrating operations for detecting an FOD voltage in the first step described above. The objective lens is moved toward the disc by applying a sweep voltage to the actuator. The level of the PE signal for the reflected light increases at a plurality of focus positions including a surface of the disc or a recording surface of the disc, and the positions where the signal level is maximized (A1, A2) are determined as a recording surface of the disc. In this case, the recording surface can be detected more accurately by repeatedly performing sweeping to confirm the maximum value at two positions (A1, A2) as shown in the figure. Then the FOD voltage V1 for maximizing the PE signal (for focusing on the recording surface of the disc) is obtained.

### [Second Step]

The disc is rotated (S104), and the FOD voltage V1 obtained in the preceding step (S103) is applied to the actuator (S105). With the operations, the light beam is focused to a level corresponding to a recording surface of the disc when the disc is not rotated. Based on the position, a wobbling signal (sine wave) is superimposed to the FOD voltage V1 to detect a PE signal (S106). In this step, feedback control is provided so that the PE maximum value is detected to acquire an FOD voltage V2 to be applied to a recording surface of the disc when the disc rotates (to accommodate vertical deviation of the disc) (S107). Then the acquired FOD voltage V2 is stored in a memory of a microcomputer or the like (sine wave learning process).

Key points in the sine wave leaning process are as described below.

(1) A wobbling signal (sine wave 2) is superimposed to the FOD voltage V1 corresponding to a recording surface of the disc when the disc is stopped so as to vibrate the objective lens in a sine wave. (2) A sine wave having the same phase as that of the sine wave 2 is input to subject the sine wave 1 to the AGC processing by referring to the PE signal level detected when the lens is vibrating. (3) An asymmetric component is extracted by subjecting the sine wave 1 signal having been subjected to the AGC processing to LPF, and the asymmetric component is detected as a defocusing rate to accommodated vertical deviation during rotation of the disc.

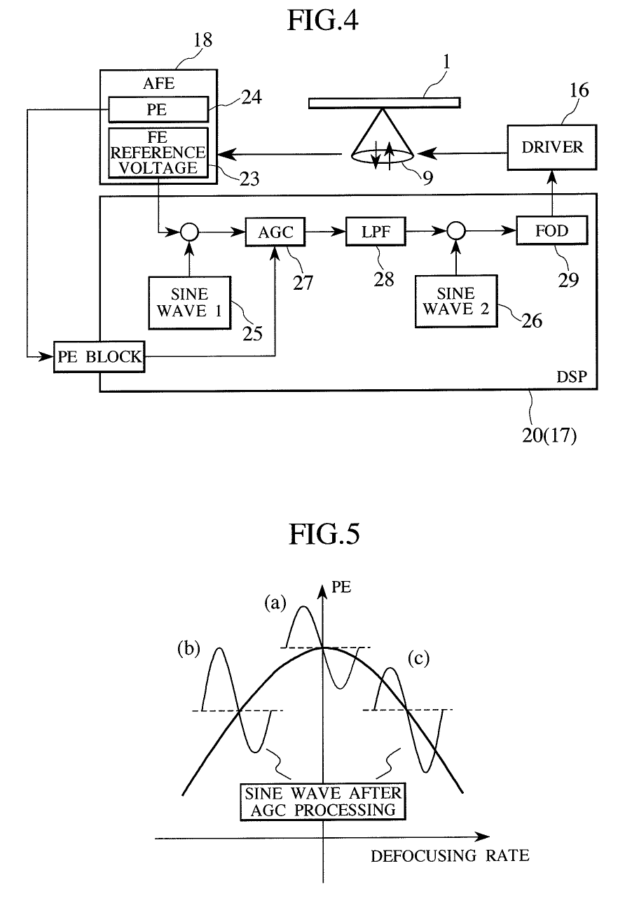

FIG. 4 is a block configuration diagram used in the sine wave learning process in step 2 above. The focus control section 17 generates a sine wave 2 with a wobbling signal generating circuit 26, superimposes the generated sign wave 2 on a focus driving voltage (FOD) 29, and supplied the superimposed signal to the driver 16. The actuator 9 vibrates the objective lens in the focusing direction (in the vertical direction) according to the sine wave 2 signal. The wobbling signal is, for instance, a sine wave with the frequency of 689 KHz, and it is assumed herein that the amplitude is sufficiently small. A reflected optical signal from the optical disc 1 is processed in the signal processing circuit (AFE) 18 to generate a summation signal (PE signal) 24. A focus reference voltage 23 is used for adjusting the focus offset. The generated PE signal is sent to the microcomputer (DSP) 20. THE DSP 20 generates a wobbling signal (sine wave 1) 25 synchronized with the wobbling signal (sine wave 2) 26. The sine wave 1 signal 25 and the PE signal 24 are input to an automatic gain control (AGC) circuit 27 to adjust an amplitude of the sine wave 1 signal 25 for gain control by referring to a level of the PE signal 24. Then the signal wave 1 signal 25 is rectified (smoothed) in a low-pass filter (LPF) circuit 28 to extract an asymmetric component of the amplitude of the sine wave 1. The extracted asymmetric component is added as a defocusing rate (a focus offset voltage) to the focus driving voltage (FOD) 29 for compensation. As described above, in the sine wave learning processing according to the present embodiment, a focus position is shifted to a position corresponding to the maximum of the PE signal by the feedback control.

FIG. 5 is a view illustrating a principle of detection of a defocusing rate in the sine wave learning process. The horizontal axis indicates a defocusing rate, and the origin indicates a just focus position. The vertical axis indicates a level of a PE signal obtained from reflected light, and the level is maximized at the just focus position. The level of the PE signal is reduced as the defocusing rate is away from the just focus position. The gain adjustment in the AGC 27 is performed so that the gain is made larger when the PE signal level attenuates. By subjecting the sine wave 1 to the AGC processing by referring to a level of the PE signal, the current defocusing rate and the direction can be detected. In the figure, three forms of the sine wave 1 (asymmetry) having been subjected to the AGC processing are shown for comparison.

(a) When it is not necessary to perform defocusing (at the just focus position), the gain adjustment rage in the AGC on the plus side of the sine wave 1 is equal to that on the minus side thereof, and as a result, the plus side and the minus side of the sine wave 1 having been subjected to the AGC processing is symmetrical. When the sine wave 1 is rectified by the LPF 28 which filters signal waves with a frequency lower than that of the sine wave, the output voltage is reduced to zero (0). Because of the operation, it is detected that the defocusing rate for compensating vertical deviation of a disc when the disc is rotated is equal to zero (0).

(b) When defocusing is performed on the minus side of the sine wave 1, the gain adjustment rate in the AGC on the plus side of the sine wave 1 is larger than that on the minus side, and as a result, an asymmetric sine wave 1 with the amplitude on the plus side larger than that on the minus side can be obtained. By rectifying the asymmetric sine wave 1 by the LPF, a minus voltage indicating the asymmetric component is outputted. With the operation, it is detected that the defocusing rate for compensating the vertical deviation is smaller than zero (<0).

(c) When defocusing is performed on the plus side, the gain adjustment in the AGC on the minus side of the sine wave 1 is larger than that on the plus side, and as a result the asymmetric sine wave 1 with the amplitude on the minus side is larger than that on the plus side. By rectifying the asymmetric sine wave 1 by the LPF, a minus voltage indicating the asymmetric component is outputted. With the operation, it is detected that the defocusing rate for compensating vertical deviation is larger than zero (>0).

The sine wave learning process is continued until a disc rotates at least once, and the FOD maximum voltage at which the objective lens comes closest to the disc (namely at which the possibility of collision between the objective lens and the disc is highest) is obtained as the FOD voltage V2. When the rotating speed becomes high, vertical deviation of the disc is suppressed and reduced by the Coriolis force. Therefore it is preferable to perform the sine wave learning process at a low rotating speed at which large vertical deviation is generated, because a focus position is set in the safer side. Deviation in sensitivity of an actuator can be corrected with a temperature sensor.

### [Third Step]

A margin value a is added to the FOD voltage V2 obtained in the second step to set a limit value V3 for the focus sweep voltage (S108). The margin value a is a value corresponding to 10% of the FOD voltage V2. Then an operation for focusing is performed (S109). It is needless to say that, in this step, an operation for focusing is performed in a range in which the FOG voltage is not over the limit value V3. If focusing can not be performed even when the FOD voltage reaches the limit value V3, the focusing operation is retried at the sweeping start point. In focusing, a focus error signal (FE signal) is detected from reflected light, and focus servo is turned ON at a point near the zero crossover point of an amplitude of the sinusoidal wave. When focusing is successful (in the state where servo is turned ON), the desired operation for recording or reproducing information to and from the disc is performed (S110).

In the embodiment of the present invention, at first, vertical deviation of a disc when the disc rotates is detected. A limit value for focus sweeping is set by taking into considerations the vertical deviation. Therefore, focusing can be performed in safety even during rotation of a disc. Furthermore wobbling vibration (sine wave) is applied to an objective lens to obtain a summation signal (PE signal), and vertical deviation of the disc during rotation thereof is detected based on the summation signal (PE signal). Since the vertical deviation can be detected during rotation of the disc 1, the sine wave learning process can be carried out within an extremely short period of time. Because of the features as described above, even when a distance between a disc and an objective lens is extremely small as in the case of a BD disc, the focusing operation can be performed in safety and more accurately.

What is claimed is:

1. An optical disc device for recording and reproducing a signal by irradiating a light beam onto an optical disc, the optical disc device comprising:
a spindle motor which rotates the optical disc;
a pickup including a laser beam source which generates the light beam, an objective lens which irradiates a light beam onto the optical disc, a photo detector which detects light reflected from the optical disc, and an actuator which shifts the objective lens in a focusing direction of the optical disc; and
a focus control section which performs focus control by giving a focus driving signal to the actuator,
wherein, when starting the focus control, the focus control section detects an amplitude of vertical deviation of the optical disc from an optical signal reflected from the disc, which is obtained by giving minute wobbling to the objective lens in the state where the disc is rotated, sets limit values for preventing the objective lens from colliding with the optical disc when the objective lens is shifted toward the optical disc, and performs focusing within a range defined by the limit values.

2. The optical disc device according to claim 1,
wherein, when starting the focus control, at first the objective lens is shifted in the state where the optical disc is stopped to detect a focus position on a recording surface of the optical disc, and then the wobbling is given to the objective lens for a region around the focus position.

3. The optical disc according to claim 1, wherein the focus control section comprises:
a wobbling signal generating circuit which generates a wobbling signal to be given to the objective lens to detect an amplitude of vertical deviation of the optical disc during rotation thereof;
a signal processing circuit which generates a summation signal from a reflected optical signal from the optical disc;
an automatic gain control circuit which references the generated summation signal and adjusts a gain of a wobbling signal synchronized with the wobbling signal; and
a low-pass filter circuit which rectifies the gain-adjusted wobbling signal.

4. A method for focus control for controlling a focus position of a light beam irradiated to a recording surface of an optical disc, the method comprising the steps of:
giving minute wobbling to an objective lens used for irradiating a light beam in the state where the optical disc rotates;
detecting an amplitude of vertical deviation of the optical disc from a reflected optical signal from the optical disc;
setting limit values for preventing the objective lent from colliding with the optical disc when the objecting lens is shifted toward the optical disc; and
shifting the objective lens for focusing toward the optical disc in the focusing direction within a range defined by the limit values.

5. The method for focus control according to claim 4,
wherein, when detecting an amplitude of vertical deviation of the optical disc, at first, a focus position on a recording surface of the optical disc is detected by shifting the objective lens in the state where the optical disc is stopped, and then the wobbling is generated to the objective lens for a region around the focus position.
